(19) United States
(12) Patent Application Publication
(10) Pub. No.: US 2026/0030566 A1
(43) Pub. Date: Jan. 29, 2026

(54) OPERATION PLANNING SYSTEM

(71) Applicants: TOYOTA JIDOSHA KABUSHIKI KAISHA, Toyota-shi (JP); THE UNIVERSITY OF TOKYO, Tokyo (JP)

(72) Inventors: Hiroyuki NAKATANI, Gotenba-shi (JP); Yoshiharu SAITO, Gotenba-shi (JP); Hayato MASUKI, Fuji-shi (JP); Kazutaka KIMURA, Mishima-shi (JP); Kenji TANAKA, Tokyo (JP); Daishi SAGAWA, Tokyo (JP)

(73) Assignees: TOYOTA JIDOSHA KABUSHIKI KAISHA, Toyota-shi (JP); THE UNIVERSITY OF TOKYO, Tokyo (JP)

(21) Appl. No.: 19/252,594

(22) Filed: Jun. 27, 2025

(30) Foreign Application Priority Data
Jul. 29, 2024 (JP) 2024-122134

(51) Int. Cl. G06Q 10/0631; G06Q 50/06

(52) U.S. Cl. CPC G06Q 10/0631; G06Q 50/06

(57) ABSTRACT

An operation planning system plans operation of a transport ship that collects energy from a plurality of floating bodies that store energy by generating power while automatically sailing. The operation planning system comprises an estimator and a planner. The estimator is configured to estimate a storing time, which is a time at which energy stored in each of the plurality of floating bodies reaches a predetermined amount. The planner is configured to generate an operation plan of the transport ship such that operation time of the transport ship approaches the storing time. The operation time is sum of a first time, a second time and a third time. The planner sets a number of floating bodies according to the first time.

### CROSS-REFERENCE TO RELATED APPLICATIONS

This application is based upon and claims the benefit of priority of the prior Japanese Patent Application No. 2024-122134, filed on Jul. 29, 2024, the entire contents of which are incorporated herein by reference.

### BACKGROUND

### 1. Technical Field

Embodiments of the present disclosure relate to the technical field of an operation planning system for planning operation of a transport ship.

### 2. Description of the Related Art

As a system of this type, a system that supports operation of ships transporting materials has been proposed (refer to JP 5953219 B (Patent Literature 1)).

The technology described in Patent Literature 1 does not consider that a transport ship collects energy generated by offshore power generation.

### SUMMARY

In view of the aforementioned problems, it is therefore an object of embodiments of the present disclosure to provide an operation planning system that generates an operation plan for a transport ship that can efficiently collect energy generated by offshore power generation.

One aspect of an operation planning system of the present disclosure is an operation planning system for planning operation of a transport ship that collects energy from a plurality of floating bodies that store energy by generating power while automatically sailing, the operation planning system comprising: an estimator configured to estimate a storing time, which is a time at which energy stored in each of the plurality of floating bodies reaches a predetermined amount; and a planner configured to generate an operation plan of the transport ship such that operation time of the transport ship approaches the storing time, wherein the operation time is sum of a first time, a second time and a third time, the first time is a time required for the transport ship to collect energy from the plurality of floating bodies, the second time is a time required for the transport ship to deliver energy at a port, the third time is a time required for the transport ship to travel between a point, at which the transport ship collects energy from the plurality of floating bodies, and the port, wherein the planner sets a number of the plurality of floating bodies according to the first time.

### BRIEF DESCRIPTION OF THE DRAWINGS

FIG. 1 is a conceptual diagram showing concept of a power generation system of an embodiment.

FIGS. 2A and 2B is a diagram showing an example of a floating body of the embodiment.

FIG. 3 is a flowchart showing operation of a transport ship and the floating body of the embodiment.

FIG. 4 is a block diagram showing configuration of an operation planning system of the embodiment.

### DETAILED DESCRIPTION OF THE EMBODIMENTS

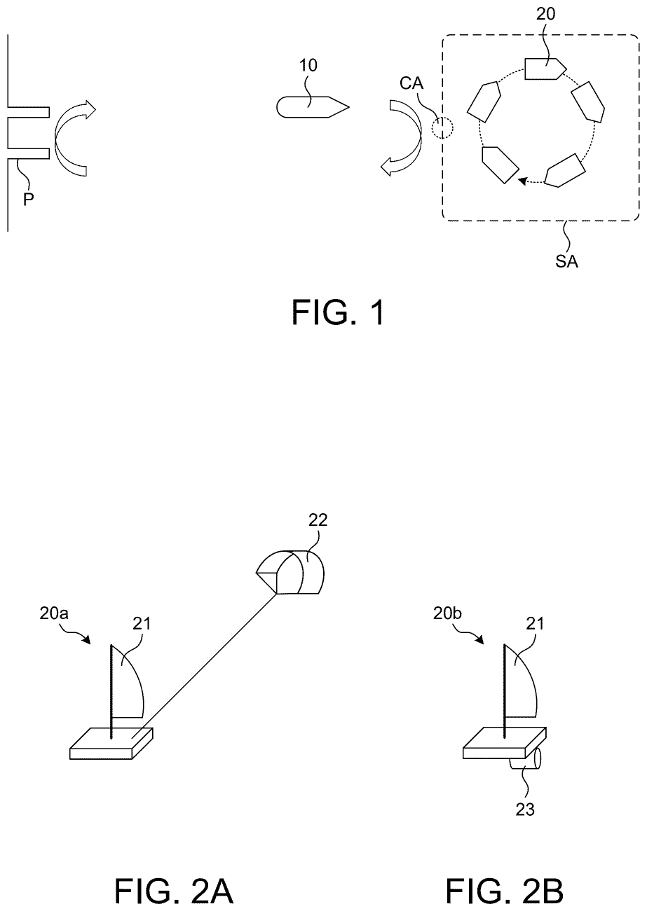

An embodiment of an operation planning system will be explained with reference to FIGS. 1 to 4.

### Configuration of the Power Generation System

A configuration of a power generation system will be explained with reference to FIG. 1 and FIGS. 2A and 2B. In the power generation system of this embodiment, power is generated in the sea area SA, which is relatively far from land, using a plurality of floating bodies 20 that do not require mooring. The plurality of floating bodies 20 automatically sail within the sea area SA. In other words, each of the plurality of floating bodies 20 generates power while automatically sailing within the sea area SA. For example, the sea area SA may be a sea area 50 kilometers away from land. As shown in FIG. 1, the plurality of floating bodies 20 form a line. By forming a line, the plurality of floating bodies 20 can suppress interference between the floating bodies 20. As a result, the power generation efficiency of one floating body 20 can be suppressed due to other floating bodies 20.

The floating body 20 will be explained with reference to FIGS. 2A and 2B. In FIG. 2A, a floating body 20a as a floating body 20 is provided with a sail 21 and a kite 22. The floating body 20a may use the wind energy received by the sail 21 as propulsion. In the floating body 20a, the tether that moors the kite 22 is uncoiled from a winch (not shown) as the kite 22 rises. The drum of the winch rotates due to the operation of the tether being reeled out. Power generation is carried out by the generator (not shown in the figure) rotating in conjunction with the rotation of the drum. After the tether has been reeled out to a predetermined length or a predetermined amount of time has elapsed, the drum of the winch is rotated in the direction of winding up the tether by the motor of the winch. As a result, the kite 22 descends due to the operation of the tether being reeled in. On the floating body 20a, power generation is carried out by repeating the process of extending and retracting the tether. In other words, tether-type wind power generation is carried out on the floating body 20a. In addition, the floating body 20a may also use the wind energy received by the kite 22 as propulsion.

In FIG. 2B, the floating body 20b has a sail 21 and an underwater turbine generator 23. The floating body 20b may use the wind energy received by the sail 21 as propulsion. As the floating body 20b moves, seawater flows into the underwater turbine generator 23. As a result, power generation is carried out by the underwater turbine generator 23.

In addition, the floating body 20a may be equipped with an underwater turbine generator 23. In other words, the floating body 20a may generate power using the underwater turbine generator 23 in addition to tether-type wind power generation. Similarly, the floating body 20b may be equipped with a kite 22. In other words, the floating body 20b may generate power using the underwater turbine generator 23 in addition to tether-type wind power generation.

The floating body 20 may store the power generated in a storage battery (e.g., a lithium-ion battery). In other words, the floating body 20 may store electrical energy as electrical energy. The floating body 20 may generate hydrogen by electrolyzing water using the power generated. The floating body 20 may store the generated hydrogen. In other words, the floating body 20 may store electrical energy as hydrogen energy. In addition, hydrogen may be stored by compression or by absorption into a hydrogen storage alloy. In addition, the floating body 20 may generate ammonia using the hydrogen generated above. The floating body 20 may store the generated ammonia. In other words, the floating body 20 may store electrical energy as ammonia energy.

Returning to FIG. 1, the transport ship 10 sails between the port P on land and the sea area SA. For example, the transport ship 10 may collect energy from the plurality of floaters 20 in the area CA on the port P side of the sea area SA. For example, if the floaters 20 are storing energy in storage batteries, the transport ship 10 may collect the storage batteries from the floaters 20 in a charged state. In this case, the transport ship 10 may install an uncharged storage battery on the floating body 20. In other words, the transport ship 10 may switch the storage batteries in area CA. For example, if the floating body 20 is storing energy by compressing and storing hydrogen in a hydrogen tank, the transport ship 10 may collect the hydrogen tank from the floating body 20. At this time, the transport ship 10 may install an empty hydrogen tank on the floating body 20. In other words, the transport ship 10 may switch the hydrogen tanks in area CA. Furthermore, area CA may mean an area where the transport ship 10 and floating body 20 can meet and an area where the route of the floating body 20 is not affected by the transport ship 10.

### Operation of the Transport Ship 10 and the Floating Body 20

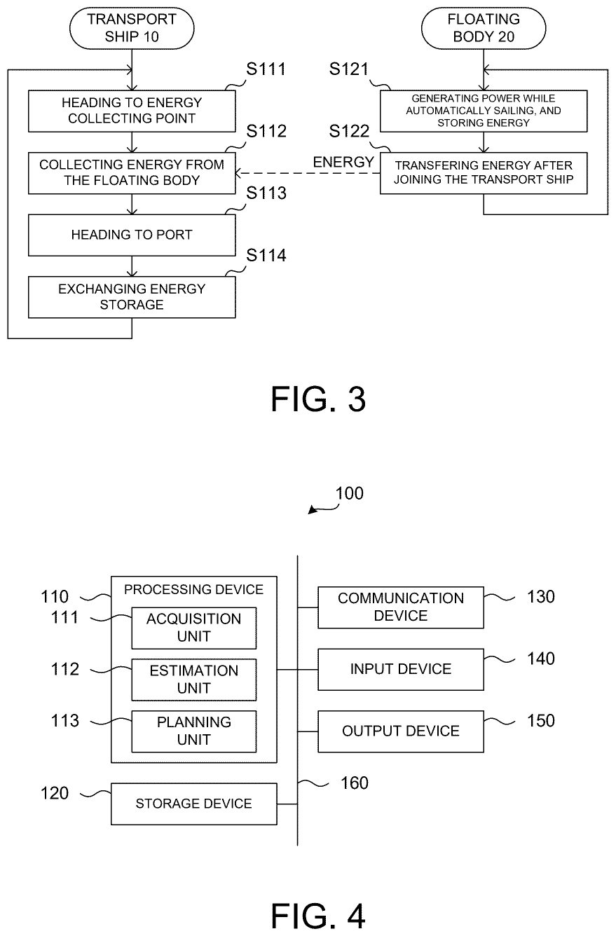

Next, operation of the transport ship 10 and the floating body 20 in the power generation system will be explained with reference to a flowchart in FIG. 3. In FIG. 3, the transport ship 10 heads from port P to the energy collecting point (e.g., area CA) (step S111). At this time, each floating body 20 generates power and stores energy while automatically sailing within sea area SA (step S121).

When the transport ship 10 arrives at the energy collecting point and the transport ship 10 and the floating body 20 meet, the floating body 20 transfers energy to the transport ship 10 (step S122), and the transport ship 10 collects energy from the floating body 20 (step S112). For example, the transport ship 10 may collect a storage battery, which has stored electrical energy, from the floating body 20, and install an uncharged storage battery on the floating body 20. For example, the transport ship 10 may collect a hydrogen tank, which has stored hydrogen, from the floating body 20, and install an empty hydrogen tank on the floating body 20.

After processing in the step S122, the floating body 20 performs processing in Step S121. In other words, the floating body 20 generates power while automatically sailing within the sea area SA. After processing in the step S112, the transport ship 10 heads to the port P from the energy collecting point (Step S113). After the transport ship 10 arrives at the port P, the transport ship 10 exchanges the energy storage (e.g., storage battery or hydrogen tank) (step S114). For example, if the transport ship 10 collects a charged storage battery from the floating body 20, the transport ship may unload the charged storage battery and load an uncharged storage battery. For example, if the transport ship 10 collects a hydrogen tank, which has stored hydrogen, from the floating body 20, the transport ship 10 may unload the hydrogen tank and load an empty hydrogen tank. The transport ship 10 then performs the processing of the step S111. In other words, the transport ship 10 heads from the port P to the energy collecting point.

In this way, the power generation system in question involves offshore power generation using the plurality of floating bodies 20 and energy transportation using transport ship 10.

### Operation Planning System

For example, if the floating body 20 stores the power generated in the storage battery, when the storage battery is fully charged, the floating body 20 will no longer be able to store power in the storage battery. For example, if the floating body 20 generates hydrogen using the power generated by the power generation system and compresses and stores the generated hydrogen in a hydrogen tank, when the hydrogen tank is full, the floating body 20 will be unable to store any more hydrogen in the hydrogen tank. Therefore, when the storage battery is fully charged or the hydrogen tank is full, the floating body 20 will be unable to store any more energy until the transport ship 10 comes to collect it. In other words, the operational efficiency of the power generation system will decrease.

In this embodiment, an operation planning system 100 generates an operation plan for the transport ship 10. The operation planning system 100 will be explained with reference to FIG. 4. In FIG. 4, the operation planning system 100 is provided with a processing device 110, a storage device 120, a communication device 130, an input device 140, and an output device 150. The processing device 110, the storage device 120, the communication device 130, the input device 140, and the output device 150 may be connected via a data bus 160. Furthermore, the operation planning system 100 may not be equipped with at least one of the input device 140 and the output device 150.

The processing device 110 may have at least one of a CPU (central processing unit) and a GPU (graphics processing unit). In other words, the processing device 110 may have a processor.

The storage device 120 may have at least one of the following: random access memory (RAM), read-only memory (ROM), hard disk drive, optical disk drive, solid state drive (SSD), and optical disk array.

The communication device 130 may be capable of communicating with devices external to the operation plan system 100. As examples of devices external to the operation plan system 100, devices mounted on the transport ship 10 and devices mounted on each of the plurality of floaters 20 can be cited. The communication device 130 may perform wired communication or wireless communication.

The input device 140 is a device that can accept input of information to the operation planning system 100 from the outside. The input device 140 may include an operation device (e.g., a keyboard, mouse, touch panel, etc.) that can be operated by a user (e.g., an operator) of the operation planning system 100. The input device 140 may include a recording medium reader that can read information recorded on a recording medium that can be attached to or detached from the operation planning system 100, such as a USB (Universal Serial Bus) memory. In addition, when information is input to the operation planning system 100 via the communication device 130 (in other words, when the operation planning system 100 acquires information via the communication device 130), the communication device 130 may function as an input device.

The output device 150 is a device that can output information to the outside of the operation planning system 100. The output device 150 may output the above information as visual information such as text and images, auditory information such as sound, or tactile information such as vibration. The output device 150 may include, for example, at least one of a display, a speaker, a printer, and a vibration motor. The output device 150 may be able to output information to a removable recording medium such as a USB memory stick that can be connected to the operation planning system 100. In addition, when the operation planning system 100 outputs information via the communication device 130, the communication device 130 may function as an output device.

The storage device 120 is capable of storing desired data. The storage device 120 may store the computer program executed by the processing device 110. The storage device 120 may temporarily store data temporarily used by the processing device 110 when the processing device 110 is executing the computer program.

In addition, the computer program may be recorded on a recording medium that is readable by a computer and is not temporary. In this case, the operation planning system 100 may read the computer program from the above-mentioned recording medium using a recording medium reader. In addition, at least one of the above-mentioned recording media, such as an optical disk, magnetic media, an optical magnetic disk, a semiconductor memory, and any other media capable of storing programs, may be used. In addition, the operation planning system 100 may acquire a computer program from an external device not shown in the diagram via the communication device 130.

For example, by executing a computer program stored in the storage device 120, the processing device 110 may realize logical functional blocks for executing the processing to be performed by the operation planning system 100 within the processing device 110.

As shown in FIG. 4, the processing device 110 may have an acquisition unit 111, an estimation unit 112, and a planning unit 113, as logically realized functional blocks or as physically realized processing circuits. Furthermore, at least one of the acquisition unit 111, the estimation unit 112, and the planning unit 113 may be realized in a form that mixes logical functional blocks and physical processing circuits (i.e., hardware).

The acquisition unit 111 may acquire meteorological and oceanographic information for the area in which the transport ship 10 sails, as well as meteorological and oceanographic information for the area SA in which the plurality of floaters 20 generate power. For example, the acquisition unit 111 may acquire at least one of the meteorological and oceanographic information from a public institution (e.g., the Japan Meteorological Agency, the Japan Coast Guard, etc.) via the communication device 130. For example, if at least one of the transport ship 10 and the floating body 20 is equipped with a measuring device, the acquisition unit 111 may acquire at least one of the meteorological information and the oceanographic information from at least one of the transport ship 10 and the floating body 20 via the communication device 130.

The estimation unit 112 estimates the storage time, which is the time at which the energy stored in each of the plurality of floaters 20 reaches a predetermined amount, based on the meteorological information and oceanographic information for the sea area SA. For example, if the floating body 20 stores the power generated in the storage battery, the above-mentioned predetermined amount may be the amount of electricity stored in the storage battery to achieve a full charge. For example, if the floating body 20 generates hydrogen using the power generated in the floating body 20 and compresses and stores the generated hydrogen in a hydrogen tank, the above-mentioned predetermined amount may be the maximum amount of hydrogen that can be stored in the hydrogen tank. In this case, the energy reaching the predetermined amount may mean that the hydrogen tank is full.

For example, the planning unit 113 may calculate the first time required for the transport ship 10 to collect energy from each of the plurality of floating bodies 20 based on the storage replacement speed of the transport ship 10. Here, the first time may be a concept that includes the time to collect storage (e.g., a rechargeable battery or a hydrogen tank storing hydrogen) from the floating body 20 and the time to install new storage (e.g., a non-rechargeable battery or an empty hydrogen tank) in the floating body 20. In other words, the first time may mean the time required to replace the storage of the floating body 20. Furthermore, the calculation of the first time may be carried out by the estimation section 112 instead of the planning unit 113.

For example, the storage replacement rate may be expressed as the weight that can be replaced per unit time. For example, if the storage replacement rate is 10 tons per hour and the weight of the storage installed on one floating body 20 is 10 tons, the time required for a transport ship 10 to collect the storage from one floating body 20 and install new storage on the floating body 20 will be one hour. The storage replacement rate may also be referred to as the cargo handling efficiency.

For example, the planning unit 113 may calculate the second time required for the transport ship 10 to deliver energy at the port P based on the storage replacement speed of the transport ship 10 and the port P. Here, the second time may be a concept that includes the time for unloading storage (e.g., a rechargeable battery or a hydrogen tank containing hydrogen) from the transport ship 10 and the time for loading new storage (e.g., a non-rechargeable battery or an empty hydrogen tank) onto the transport ship 10. In other words, the second time may refer to the time required to replace the storage on the transport ship 10. Furthermore, the calculation of the second time may be performed by the estimation unit 112 instead of the planning unit 113.

For example, the planning unit 113 may calculate the third time required for the transport ship 10 to travel between the port P and the energy collecting point based on the distance between the port P and the energy collecting point (e.g., area CA) and the meteorological and oceanographic information of the sea area where the transport ship 10 sails. The calculation of the third time may be performed by the estimation unit 112 instead of the planning unit 113.

The planning unit 113 generates an operation plan for the transport ship 10 so that the total operation time of the transport ship 10, which is the sum of the first time, the second time, and the third time, approaches the storage time estimated by the estimation unit 112. Preferably, the planning unit 113 generates an operation plan for the transport ship 10 so that the operation time matches the storage time. Furthermore, “the operation time approaches the storage time” may mean “the operation time is less than or equal to the storage time, and the difference between the operation time and the storage time is as small as possible”. Furthermore, the operation time may be longer than the storage time.

For example, the planning unit 113 may set the speed of the transport ship 10 in order to make the operation time approach the storage time. In other words, the planning unit 113 may adjust the third time to bring the operation time closer to the storage time. For example, the planning unit 113 may set the number of floating bodies 20 from which the transport ship 10 should collect energy to bring the operation time closer to the storage time. In other words, the planning unit 113 may adjust at least one of the first time and the second time to bring the operation time closer to the storage time.

The speed (e.g., average speed) of the transport ship 10 and the distance between the port P and the energy collecting point can be determined with relatively high accuracy. Therefore, the accuracy of the above-mentioned third time can be expected to be relatively high. For example, the planning unit 113 can obtain the exchange time (i.e., the time that can be spent on exchanging storage, which is the sum of the first time and the second time) that can be spent on exchanging storage by subtracting the third time from the storage time estimated by the estimation unit 112. The planning unit 113 may set the number of floating bodies 20 from which the transport ship 10 collects energy based on the replacement time.

For example, if the storage time is 20 hours and the third time is 10 hours, the replacement time will be 10 hours. For example, assume that the storage replacement rate at the energy collecting point is 10 tons per hour and the storage replacement rate at port P is 10 tons per hour. In this case, the first hour is 10 hours×(10 tons per hour/(10 tons per hour+10 tons per hour))=10 hours/2 =5 hours. Suppose that the weight of the storage on one floating body 20 is 10 tons. In this case, the planning unit 113 may set the number of floating bodies 20 from which the transport ship 10 collects energy to 5 in order to bring the operation time closer to the storage time.

For example, let's say that the storage replacement rate at the energy collecting point is 10 tons per hour, and the storage replacement rate at port P is 30 tons per hour. In this case, the first hour would be 10 hours×(30 tons per hour/(10 tons per hour+30 tons per hour))=10 hours×¾=7.5 hours. Let's say that the weight of the storage on one floating body 20 is 10 tons. In this case, the planning unit 113 may set the number of floating bodies 20 from which the transport ship 10 collects energy to 7 or 8 in order to make the operation time closer to the storage time.

The planning unit 113 may transmit the operation plan for the transport ship 10 to the transport ship 10 via the communication device 130. The operation plan system 100 may generate the operation plan for the transport ship 10 before the operation of the power generation system described above (in other words, it may simulate the operation of the power generation system). In this case, the planning unit 113 may display the operation plan for the transport ship 10 on a display as an example of the output device 150. For example, a user of the operation planning system 100 may estimate the number of transport ships 10 that should be prepared in accordance with the scale of power generation (e.g., the number of floating bodies 20) by taking into account the operation plan of the transport ship 10.

### Technical Effect

In the operation planning system 100, an operation plan for the transport ship 10 is generated so that the operation time approaches the storage time (preferably, so that the operation time matches the storage time). In order to make the operation time approach the storage time, the operation planning system 100 sets the number of floating bodies 20 from which the transport ship 10 collects energy. For example, the operation planning system 100 may set the number of floating bodies 20 from which the transport ship 10 collects energy according to the first time. Therefore, the operation planning system 100 can relatively easily bring the operation time closer to the storage time. If the transport ship 10 is operated according to the operation plan of the transport ship 10, energy can be collected efficiently from plurality of floating bodies 20. In other words, according to the operation planning system 100, the power generation system (in other words, the transport ship 10 and the plurality of floaters 20) can be operated efficiently.

### First Modified Embodiment

Due to at least one of the weather and ocean conditions in the sea area SA, the actual storage time may be shorter than the storage time estimated by the estimation unit 112 of the operation planning system 100. If no countermeasures are taken in this case, the timing of energy collecting from the floating bodies 20 will be delayed, and the operational efficiency of the power generation system will decrease.

In this case, the operation planning system 100 may change the routes of the plurality of floating bodies 20 so that the energy collecting point moves to the port P side. In this case, at least one of the location and size of the sea area SA may be changed. For example, the planning unit 113 of the operation planning system 100 may transmit information indicating the new route (i.e., the route after the change) to each floating body 20 via the communication device 130. The planning unit 113 may transmit information indicating the new energy collecting point (i.e., the energy collecting point after the change) to the transport ship 10 via the communication device 130. In this way, it is possible to suppress a decrease in the operational efficiency of the power generation system.

### Second Modified Embodiment

The transport ship 10 may be a sailing ship. In this way, the proportion of renewable energy used in the entire power generation system can be increased. On the other hand, sailing ships are easily affected by weather and ocean conditions.

For example, let's say that the sailing ship transport ship 10 is heading towards the energy collecting point according to the operation plan generated by the operation plan system 100. At this time, let's say that the transport ship 10 is unable to reach the energy collecting point according to the operation plan due to the influence of at least one of the weather and ocean conditions. If no measures are taken in this case, the timing of energy collecting from the floating bodies 20 will be delayed, and the operational efficiency of the power generation system will decrease.

In this case, the operation planning system 100 may change the routes of the plurality of floaters 20 so that the energy collecting point moves to the port P side. In this case, at least one of the location and size of the sea area SA may be changed. For example, the planning unit 113 of the operation planning system 100 may transmit information indicating the new route (i.e., the changed route) to each floater 20 via the communication device 130. The planning unit 113 may transmit information indicating the new energy collecting point (i.e., the changed energy collecting point) to the transport ship 10 via the communication device 130. In this way, it is possible to suppress a decrease in the operational efficiency of the power generation system.

Aspects of the invention derived from the above-described embodiment are explained below.

One aspect of an operation planning system is an operation planning system for planning operation of a transport ship that collects energy from a plurality of floating bodies that store energy by generating power while automatically sailing, the operation planning system comprising: an estimator configured to estimate a storing time, which is a time at which energy stored in each of the plurality of floating bodies reaches a predetermined amount; and a planner configured to generate an operation plan of the transport ship such that operation time of the transport ship approaches the storing time, wherein the operation time is sum of a first time, a second time and a third time, the first time is a time required for the transport ship to collect energy from the plurality of floating bodies, the second time is a time required for the transport ship to deliver energy at a port, the third time is a time required for the transport ship to travel between a point, at which the transport ship collects energy from the plurality of floating bodies, and the port, wherein the planner sets a number of the plurality of floating bodies according to the first time.

In this operation planning system, the planner may generate the operation plan such that the operation time matches the storing time.

Each of the plurality of floating bodies may store energy as hydrogen, and the predetermined amount may be limit amount of a tank storing hydrogen.

This invention is not limited to the above-mentioned embodiments, and can be changed as appropriate within the scope that does not contradict the gist or idea of the invention that can be read from the claims and the entire specification, and an operation planning system that involves such changes is also included in the technical scope of this invention.

What is claimed is:

1. An operation planning system for planning operation of a transport ship that collects energy from a plurality of floating bodies that store energy by generating power while automatically sailing, the operation planning system comprising:
an estimator configured to estimate a storing time, which is a time at which energy stored in each of the plurality of floating bodies reaches a predetermined amount; and
a planner configured to generate an operation plan of the transport ship such that operation time of the transport ship approaches the storing time, wherein the operation time is sum of a first time, a second time and a third time, the first time is a time required for the transport ship to collect energy from the plurality of floating bodies, the second time is a time required for the transport ship to deliver energy at a port, the third time is a time required for the transport ship to travel between a point, at which the transport ship collects energy from the plurality of floating bodies, and the port,
wherein the planner sets a number of the plurality of floating bodies according to the first time.

2. The operation planning system according to claim 1, wherein the planner generates the operation plan such that the operation time matches the storing time.

3. The operation planning system according to claim 1, wherein
each of the plurality of floating bodies stores energy as hydrogen, and
the predetermined amount is limit amount of a tank storing hydrogen.
